(19) United States
(12) Patent Application Publication
(10) Pub. No.: US 2009/0199205 A1
(43) Pub. Date: Aug. 6, 2009

(54) CONFIGURABLE GRAPHICS VIRTUAL MACHINE BASED DISPLAY SYSTEM

(75) Inventors: Kiran Gopala Krishna, Bangalore (IN); Satyanarayan Kar, Bangalore (IN); Vamsi Agasthyaraju, Bangalore (IN); Shashidhara Ganganna, Bangalore (IN); Bincicil Mathew, Bangalore (IN); Gary Thomas Hickey, Phoenix, AZ (US); William Ray Hancock, Phoenix, AZ (US)

Correspondence Address: HONEYWELL INTERNATIONAL INC.;PATENT SERVICES, 101 COLUMBIA ROAD, P O BOX 2245, MORRISTOWN, NJ, 07962-2245, US

(73) Assignee: Honeywell International Inc., Morristown, NJ (US)

(21) Appl. No.: 12/026,662

(22) Filed: Feb. 6, 2008

(51) Int. Cl. G06F 9/46; G06F 3/048

(52) U.S. Cl. 719/313; 719/318; 715/764

(57) ABSTRACT

A graphics virtual machine display system for an aircraft is provided. The graphics virtual machine display system includes a registry. An initialization block is in communication with the registry for instantiating a graphics widget. A rendering block is in communication with the initialization block for rendering the graphics widget. An event handling block is in communication with the registry for accepting an event associated with the graphics widget.

### FIELD OF THE INVENTION

The present invention generally relates to aircraft systems, and more particularly, but not exclusively, to a configurable graphics virtual machine based display system for aircraft.

### BACKGROUND OF THE INVENTION

In today's aerospace industry, it is highly desirable for aircraft systems to be upgradeable to incorporate evolving technologies. In many cases, however, a change in a core component of aircraft systems such as crew information and avionics systems may require a change in a peripheral subsystem. Implementing such a change in a peripheral subsystem may be expensive and time consuming.

Currently, aerospace companies face a variety of challenges relating to the desire to incorporate the latest technology and functionality into existing systems. These challenges include (1) minimizing the cost of acquiring new systems, such as avionics systems, (2) minimizing the cost of adding new system functionality or changing the layout, appearance or behavior of display objects during the life of a system, (3) minimizing the cost of managing hardware obsolescence in an area of rapidly evolving technology, (4) introducing greater interactivity, and (5) customizing the appearance and look and feel of graphically displayed information.

Accordingly, it is desirable to implement aerospace systems which address one or more of the challenges described above. For example, it is desirable to implement an aircraft display system capable of inexpensively and quickly integrating with aircraft display subsystems across a variety of platforms and from a variety of vendors.

Furthermore, other desirable features and characteristics of the present invention will become apparent from the subsequent detailed description of the invention and the appended claims, taken in conjunction with the accompanying drawings and this background of the invention.

### BRIEF SUMMARY OF THE INVENTION

In one embodiment, by way of example only, a graphics virtual machine display system for an aircraft is provided. The graphics virtual machine display system includes a registry. An instantiation block is in communication with the registry for instantiating a graphics widget. A rendering block is in communication with the instantiation block for rendering the graphics widget. An event handling block is in communication with the registry for accepting an event associated with the graphics widget. An input/output (I/O) block is in communication with the registry to decode/encode the runtime data streamed into and out of the system.

In another embodiment, again by way of example only, a method of generating a graphics widget on an aircraft display device is provided. An attribute of the graphics widget is captured. A bytecode representative of the attribute of the graphics widget is generated. The bytecode is stored in a widget library. The graphics widget is instantiated in a graphics virtual machine using the bytecode.

In still another embodiment, again by way of example only, a computer program product for generating a graphics widget on an aircraft display is provided. The computer program product comprises a computer-readable storage medium having computer-readable program code portions stored therein. The computer-readable program code portions comprise a first executable portion configured to capture an attribute of the graphics widget, a second executable portion configured to generate a bytecode representative of the attribute of the graphics widget, a third executable portion configured to store the bytecode in a widget library, and a fourth executable portion configured to instantiate the graphics widget and facilitate communication with a rendering block, an event handling block and an I/O block in a graphics virtual machine.

### BRIEF DESCRIPTION OF THE DRAWINGS

The present invention will hereinafter be described in conjunction with the following drawing figures, wherein like numerals denote like elements, and

FIG. 1 is a block diagram of an exemplary configurable graphics virtual machine based display system for an aircraft;

FIG. 2 illustrates a first exemplary method for developing a rendering bytecode;

FIG. 3 illustrates a second exemplary method for developing an event handling bytecode; and

FIG. 4 illustrates a third exemplary method for capturing standards/specification grammar in the form of a bytecode or extensible markup language (XML).

### DETAILED DESCRIPTION OF THE INVENTION

The following detailed description of the invention is merely exemplary in nature and is not intended to limit the invention or the application and uses of the invention. Furthermore, there is no intention to be bound by any theory presented in the preceding background of the invention or the following detailed description of the invention.

The present description and following claimed subject matter present exemplary system, method, and computer program product embodiments of a highly configurable graphics virtual machine based display system for an aircraft. However, other vehicles and vehicle systems, such as automobiles and automotive systems, marine vehicles and systems, and the like, may incorporate various functionality described herein in a similar manner.

These embodiments may utilize a graphics virtual machine to organize attributes of graphical display objects. Throughout this specification, the graphical objects and accompanying and related data may be referred to as “graphics widgets.” A graphics widget, for example, may include a graphic object displayed on a graphics screen. A single aircraft display page may include several graphics widgets, each graphics widget positioned uniquely on the screen to prevent any overlap of the objects. An example of a graphics widget is a radial oil level indicator with a numeric display. The radial dial of the indicator consists of a pointer indicating the level of the oil quantity over an arc extending 315 degrees to 160 degrees on the circumference. The numeric display is positioned within the circumference, typically between the 180 to 270 degree quadrants. The pointer color and numeric display color may be configured to change to amber when the oil quantity lies in a specific range and red when the oil quantity falls below a pre-determined value, for example.

These embodiments may utilize a graphics virtual machine to organize the graphics widgets wherein several graphics widgets overlap to create a composite graphical object. An example of a composite graphical object is an attitude direction indicator. The attitude direction indicator consists of two filled areas to represent the sky and the ground, a scale overlapping on the filled area to represent the pitch ladder and the roll scale, an airplane symbol with associated cues like flight director, flight path vector, speed and guidance cues overlap on the pitch ladder.

The attributes of graphics widgets are organized, stored, and retrieved in such a manner as to enable their display using a variety of platforms and formats. In this way, a particular aircraft display subsystem may utilize the graphics virtual machine to share graphics information with another aircraft display subsystem compatible with a differing platform, format, or specification.

Organization of graphics widget attributes may be aided by the conversion of graphics attributes into bytecodes. The bytecodes are representative of one or more attributes of the graphics widgets. The bytecodes may take the form of a standard data format, such as extensible markup language (XML). Other features of the present description and claimed subject matter will be further described below.

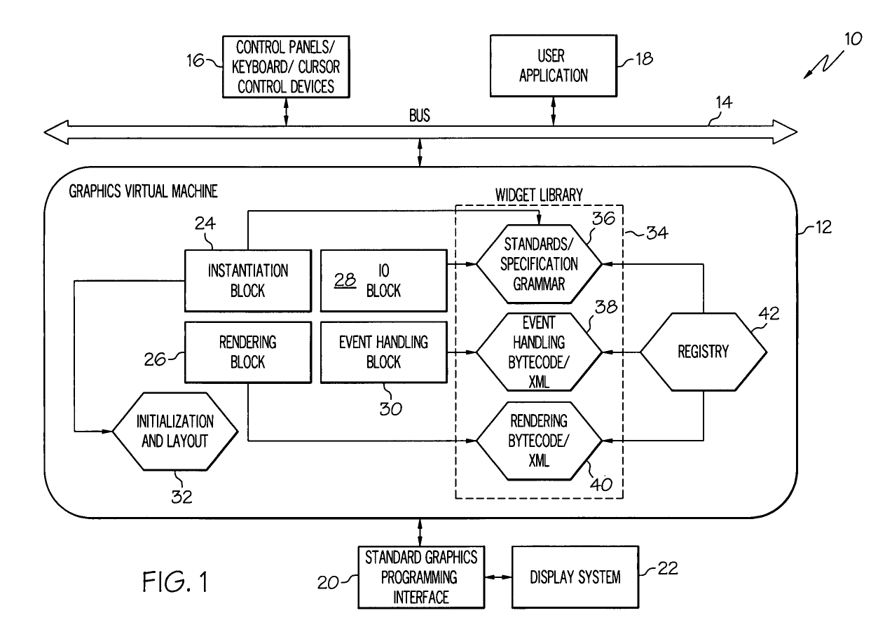

Turning to FIG. 1, a block diagram of an exemplary graphics virtual machine based display system 10 for an aircraft is depicted. Display system 10 includes a graphics virtual machine 12. Graphics virtual machine 12 may be implemented in hardware, software, firmware, or a combination thereof. For example, the graphics virtual machine may be implemented, partially or wholly, as a computer program product including a computer-readable storage medium having computer-readable program code portions stored therein. The computer-readable storage medium may include disk drives, flash memory, digital versatile disks (DVDs), compact disks (CDs), and other types of storage mediums.

Graphics virtual machine 12 may be configured to be once-certified, yet reusable in a variety of implementations. Graphics virtual machine 12 may use, and may be compatible with, a variety of industry standards such as Aeronautical, Radio Inc. (ARINC) standard 661 for cockpit displays. Graphics virtual machine 12 provides the centerpiece of a framework for (1) modeling the appearance and behavior of graphical widgets, and (2) integrating an optimized set of bytecodes resulting from the graphical and/or non-graphical and logical models of each widget.

Rules of rendering the widgets as well as the behavioral response to certain events (from a user or any other source) may be stored in a set of bytecodes. Again, these bytecodes may be stored in a standard data format, such as XML. The bytecodes may not only contain graphical commands, but also logical, control flow, and mathematical commands associated with each graphics widget.

In addition, another set of bytecodes may contain state machine information that defines the behavior response to certain events. These bytecodes may be preloaded before the startup of the display system, or streamed via a suitable bus during initialization and normal run time. The bytecodes may be organized, stored, and interpreted by the graphics virtual machine 12.

As previously mentioned, the graphics virtual machine 12 may use industry standards such as ARINC 661. As will be further described, graphics virtual machine 12 utilizes a registry 42 which is operable to build relationships between bytecodes and a specific graphics widget. These relationships may be organized in a widget library 34 as will be further described. The relationships may be one-to-one, one-to-many, many-to-one, and hierarchical in nature.

Graphics virtual machine 12 may accept and interpret industry standard definitional file requirements. In the process of this interpretation, the graphics virtual machine 12 may instantiate and initialize graphics widgets which define layout and initialization parameters associated with each graphics widget.

Graphics virtual machine 12 may set up communication with various data feeders. For example, human interface devices 16 such as control panels, keyboard devices, and/or cursor control devices may be coupled through a suitable bus 14 to the graphics virtual machine 12. Similarly, a user application 18 may be coupled through bus 14 to the graphics virtual machine 12. A graphics widget state may be dynamically updated following industry protocols such as those defined in ARINC 661, as well as by events generated by a user. These events may vary as the aircraft operates at a particular time.

Since a certain portion of intelligence for the rendering and behavioral response of widgets to certain events are stored in bytecodes which are organized into a widget library, the look and feel of display system 10 may be easily customized for human factor acceptance and/or for specific original equipment manufacturer (OEM) requirements. This is made possible because widget attributes are stored as bytecodes in a standardized data format and are not hand coded.

Once graphics virtual machine 12 becomes certified, new display pages may be implemented without additional coding. This once-certified, reusable framework avoids the necessity of additional development, increases reusability, and eliminating certification costs. The configurability features assist in rapid development and deployment of various display pages. Graphics virtual machine 12 may render and output graphical information compliant with industry-accepted graphics programming standards such as OpenGL, DirectX and the like, which reduces the chances of hardware obsolescence.

Returning to FIG. 1, graphics virtual machine 12 may be implemented as a layer between standard graphics programming interfaces 20 (coupled to aircraft display devices as part of a display system 22) and human interfaces 16 and user applications 18 connected via a bus 14 interface. As shown, graphics virtual machine 12 includes an instantiation block 24, a rendering block 26, and an input/output block 28, and an event handling block 30. Instantiation block 24 is shown in communication with initialization and layout block 32, and a standards/specification/grammar block 36 which is integrated into the widget library 34 and registry 42. Similarly, input/output block 28 is shown in communication with standards/specification/grammar block 36. Also rendering block 26 and event handling block 30 are both shown in communication with the widget library 34 and registry 42. A standards/specification/grammar block 36 is also integrated into the widget library 34 for storing and providing, for example, standards definitional information consistent with a particular industry standard.

Instantiation block 24 interprets the industry standards, such as ARINC 661's definition file, and instantiates widgets using an integrated registry 42 and standards/specification/grammar block 36. Registry 42 builds relationships between bytecodes and a specific graphics widget that may comply with industry standards. The standards/specification/grammar block 36 which is integrated into the widget library 34 provides the interpretation grammar which is specific to industry standards. An instantiation of a graphics widget may include reserving blocks of memory to store a particular state of the graphics widget, for example. Instantiation block 24 may use and/or incorporate an initialization and layout block 32 to initialize a graphics widget for operation on system 10.

I/O block 28 may be configured to receive from, and transmit to, user application 18 following formats and protocols such as those defined by the ARINC 661 specification or another industry standard. I/O Block interprets the runtime protocol by using standards/specification/grammar block 36. Upon receipt of a message, the I/O block 28 may interpret the message and update a particular block of memory reserved for an instantiation of a particular graphics widget. In this manner, a widget parameter may be updated in the graphics virtual machine 12.

Rendering block 26 renders graphics by referencing and interpreting the appropriate rendering bytecode 40, again as stored in widget library 34 and blocks of memory that store a state of a graphics widget, for example. Rendering block 26 not only may interpret graphical commands as defined in a particular bytecode, but also logical, control flow, and mathematics commands as previously described.

Event handling block 30 may be configured to accept events (from a user, another aircraft system, or another source) by interpreting another set of bytecodes dedicated to handling the behavior of graphics widgets, which may be termed event handling bytecodes 38, again as stored in widget library 34. In addition, the event handling block 30 may run a state machine defined in a particular event handling bytecode 38, referencing a block of memory reserved for a particular graphics widget.

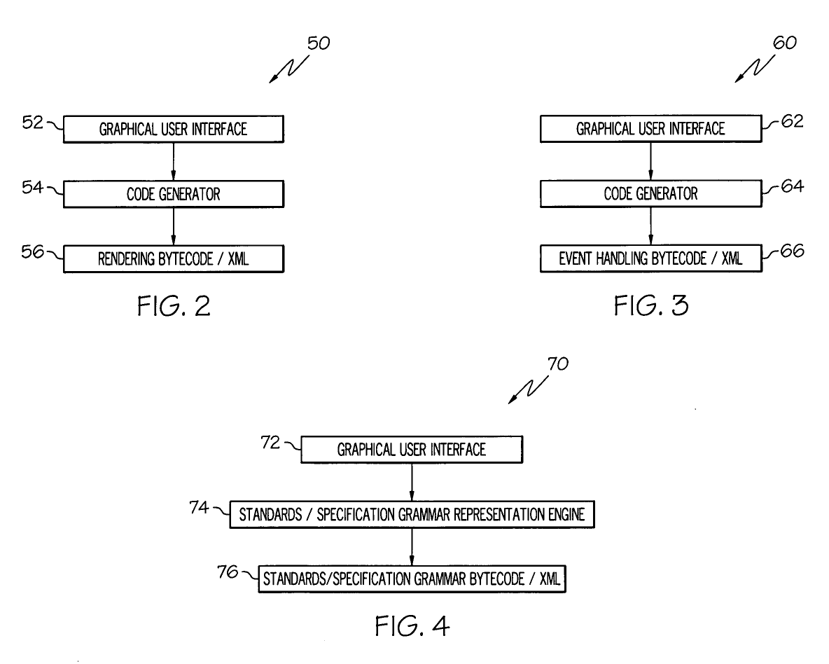

Turning to FIG. 2, a first exemplary method 50 for developing a rendering bytecode is depicted. Method 50 incorporates the functionality of a graphical user interface (GUI) which is connected to the graphics virtual machine, for example, through an appropriate bus. As a first step, the GUI may assist in modeling particular requirements of a graphics widget (step 52). As a next step, a code generator is utilized to capture attributes of a particular graphics widget (step 54). These attributes may include graphical hierarchy attributes, other graphical attributes, and control mechanisms associated with the graphics widget. The code generator creates a bytecode, or a set of bytecodes specific to the particular widget attributes (step 56). This bytecode or set of bytecodes are stored as rendering bytecodes in the widget library and controlled via the registry of the graphics virtual machine.

FIG. 3 depicts a second exemplary method 60 for developing an event handling bytecode. Again, the GUI may be used to assist in modeling particular behavioral response attributes of a graphics widget (step 62). The behavioral response attributes may then be fed into the code generator to create a bytecode, or set of bytecodes representative of the behavioral response attributes (step 64). For example, the code generator may capture state machine attributes specific to a particular graphics widget, and create an associated event handling bytecode or set of event handling bytecodes (step 66). Again, the event handling bytecodes are stored in the widget library and controlled via the registry of the graphics virtual machine.

FIG. 4 depicts a third exemplary method 70 for capturing the standards/specification grammar in the form of a bytecode or XML. Again, the GUI may be used to assist in capturing the rules of the grammar (step 72). The rules of the grammar are fed into the Standards/Specification Grammar Representation Engine (step 74) to create a bytecode or an XML (step 76). Again, the standards/specification grammar are stored in the widget library 34 and controlled via the registry 42 of the graphics virtual machine.

In light of the foregoing description, various exemplary methods for utilizing a graphics virtual machine based display system to generate a graphics widget on a display device may be implemented. These methods may include capturing an attribute of the graphics widget, generating a bytecode representative of the attribute of the graphics widget, storing the bytecode in a widget library, and instantiating the graphics widget in a graphics virtual machine using the bytecode.

These methods may further include building a standards relationship between the graphics widget and the bytecode in a registry. Capturing an attribute of the graphics widget may include capturing a graphical hierarchy, a graphical attribute, a control mechanism, or a state machine associated with the graphics widget. Once the graphics widget is initialized and instantiated on the graphics virtual machine, a message may be received from an aircraft user application, such as an event or other information. A graphics widget parameter reserved for a particular graphics widget instantiation may be updated. Additionally, an event handling bytecode may be retrieved from the widget library, a state machine defined in the bytecode may be executed, and the graphics widget may be rendered on the aircraft display device. In rendering the graphics widget, the graphics virtual machine may provide rendering data to a graphics programming interface coupled to the aircraft display device.

These methods may also include choosing an alternative relationship in the registry 42 as per the aircraft current state triggered by User Application 18 so that the graphics and the associated behavior comply with human factor requirements. On the contrary, the other representations of the widget that differ in attributes like look and/or feel can be selected/reconfigured by the User Application.

Some of the functional units described in this specification have been labeled as “blocks” in order to more particularly emphasize their implementation independence. For example, functionality labeled as a block may be implemented wholly, or partially, as a hardware circuit comprising custom VLSI circuits or gate arrays, off-the-shelf semiconductors such as logic chips, transistors, or other discrete components. A block may also be implemented in programmable hardware devices such as field programmable gate arrays, programmable array logic, programmable logic devices, or the like.

Blocks may also be implemented in software for execution by various types of processors. An identified block of executable code may, for instance, comprise one or more physical or logical blocks of computer instructions that may, for instance, be organized as an object, procedure, or function. Nevertheless, the executables of an identified block need not be physically located together, but may comprise disparate instructions stored in different locations that, when joined logically together, comprise the module and achieve the stated purpose for the block.

Indeed, a block of executable code may be a single instruction, or many instructions, and may even be distributed over several different code segments, among different programs, and across several memory devices. Similarly, operational data may be embodied in any suitable form and organized within any suitable type of data structure. The operational data may be collected as a single data set, or may be distributed over different locations including over different storage devices, and may exist, at least partially, merely as electronic signals on a system or network.

Reference throughout this specification to “one embodiment,” “an embodiment,” or similar language means that a particular feature, structure, or characteristic described in connection with the embodiment is included in at least one embodiment of the present invention. Thus, appearances of the phrases “in one embodiment,” “in an embodiment,” and similar language throughout this specification may, but do not necessarily, all refer to the same embodiment.

Furthermore, the described features, structures, or characteristics of the invention may be combined in any suitable manner in one or more embodiments. In the following description, numerous specific details are provided, such as examples of programming, software modules, user selections, network transactions, database queries, database structures, hardware modules, hardware circuits, hardware chips, etc., to provide a thorough understanding of embodiments of the invention. One skilled in the relevant art will recognize, however, that the invention may be practiced without one or more of the specific details, or with other methods, components, materials, and so forth. In other instances, well-known structures, materials, or operations are not shown or described in detail to avoid obscuring aspects of the invention.

While one or more embodiments of the present invention have been illustrated in detail, the skilled artisan will appreciate that modifications and adaptations to those embodiments may be made without departing from the scope of the present invention as set forth in the following claims.

What is claimed is:

1. A graphics virtual machine display system for an aircraft, comprising:
a registry;
an instantiation block in communication with the registry for instantiating a graphics widget;
a rendering block in communication with the instantiation block for rendering the graphics widget; and
an event handling block in communication with the registry for accepting an event associated with the graphics widget.

2. The system of claim 1, further including an input/output (I/O) block for receiving a message from a user application relating to the graphics widget.

3. The system of claim 1, further including a widget library in communication with the registry for storing the graphics widget.

4. The system of claim 3, wherein the widget library includes an event handling bytecode and a rendering bytecode associated with the graphics widget.

5. The system of claim 4, wherein the widget library includes a representation of standard/specification grammar used for interpretation and instantiation of the graphics widget.

6. The system of claim 5, wherein the event handing bytecode, rendering bytecode and the representation of standard/specification grammar are compatible with an extensible markup language (XML) format.

7. The system of claim 1, wherein the instantiation block is integrated into a graphics virtual machine.

8. The system of claim 7, wherein the graphics virtual machine is coupled between a user application and a graphics programming interface of the aircraft.

9. The system of claim 8, further including an aircraft display device coupled to the graphics programming interface.

10. A method of generating a graphics widget on an aircraft display device, comprising:
capturing an attribute of the graphics widget;
generating a bytecode representative of the attribute of the graphics widget;
storing the bytecode in a widget library; and
instantiating the graphics widget in a graphics virtual machine using the bytecode.

11. The method of claim 10, further including building a standards relationship between the graphics widget and the bytecode in a registry.

12. The method of claim 10, wherein capturing an attribute of the graphics widget includes capturing a graphical hierarchy, a graphical attribute, a control mechanism, or a state machine associated with the graphics widget.

13. The method of claim 10, further including:
receiving a message from an aircraft user application,
retrieving the bytecode from the widget library, and
rendering the graphics widget on the aircraft display device.

14. The method of claim 13, further including executing a state machine defined in the bytecode for the graphics widget.

15. The method of claim 13, further including, subsequent to receiving the message from the aircraft user application, updating a graphics widget parameter reserved for a graphics widget instantiation.

16. The method of claim 13, wherein rendering the graphics widget on the aircraft display device includes providing rendering data to a graphics programming interface coupled to the aircraft display device.

17. The method of claim 13, further including choosing an alternative relationship in the registry based on an aircraft current state to enable the graphics widget and associated behavior to comply with human factor requirements.

18. The method of claim 13, further including reconfiguring a relationship in the registry by a user application.

19. A computer program product for generating a graphics widget on an aircraft display device, the computer program product comprising a computer-readable storage medium having computer-readable program code portions stored therein, the computer-readable program code portions comprising:
a first executable portion configured to capture an attribute of the graphics widget;
a second executable portion configured to generate a bytecode representative of the attribute of the graphics widget;
a third executable portion configured to store the bytecode in a widget library; and
a fourth executable portion configured to instantiate the graphics widget in a graphics virtual machine using the bytecode.

20. The computer program product of claim 19, further including a fifth executable portion configured to build a standards relationship between the graphics widget and the bytecode in a registry.

21. The computer program product of claim 19, wherein the attribute of the graphics widget includes a graphical hierarchy, a graphical attribute, a control mechanism, or a state machine associated with the graphics widget.

22. The computer program product of claim 19, further including:
a fifth executable portion configured to receive a message from an aircraft user application,
a sixth executable portion configured to retrieve the bytecode from the widget library, and
a seventh executable portion configured to render the graphics widget on the aircraft display device.

23. The computer program product of claim 22, further including an eighth executable portion configured to execute a state machine defined in the bytecode for the graphics widget.

24. The computer program product of claim 22, further including a ninth executable portion to, subsequent to receiving the message from the aircraft user application, update a graphics widget parameter reserved for a graphics widget instantiation.
